(19) United States
(12) Patent Application Publication
(10) Pub. No.: US 2007/0166030 A1
(43) Pub. Date: Jul. 19, 2007

(54) Semiconductor device fabrication equipment and method of using the same

(76) Inventor: Myeong-Seok Lee, Osan-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/511,276

(22) Filed: Aug. 29, 2006

(30) Foreign Application Priority Data
Jan. 19, 2006 (JP) 2006-0005889

(51) Int. Cl. G03D 5/00

(52) U.S. Cl. 396/611

(57) ABSTRACT

Semiconductor device fabrication equipment and a method of using the same minimize the total time that a wafer spends being transferred through the equipment and the number of times the wafer is transferred between respective parts of the equipment. The semiconductor fabrication equipment includes a first apparatus used for performing a first process on a wafer, a second apparatus linked in-line to the first apparatus and used for performing a second process consecutive to the first process with respect to the fabrication of a semiconductor device from the wafer, and a speed regulator connected to the first and second apparatuses. The speed regulator detects durations of the first and second processes, respectively, compares the durations, and makes a determination as to whether the duration of the first process is shorter than the duration of the second process. The speed regulator is also configured to adjust the speed at which the first process is executed when the duration of the first process is shorter than the duration of the second process.

### BACKGROUND OF THE INVENTION

1. Field of the Invention

The present invention relates to a method of and equipment for fabricating a device such as a semiconductor device. More particularly, the present invention relates to fabrication equipment, such as photolithography equipment, in which a plurality of apparatuses are linked in-line, and to a method of processing substrates using the same.

2. Description of the Related Art

Basically, a semiconductor device is fabricated by repeatedly performing a plurality of individual processes, such as photoresist coating, exposure, development, etching, and deposition processes, on a wafer. Therefore, a plurality of semiconductor device fabrication apparatuses, each for performing some of the individual processes, are generally required to fabricate a semiconductor device.

Recently, various techniques have been proposed to improve the yield and reliability of semiconductor devices. One of the techniques is to construct an automated production line by connecting a plurality of semiconductor fabrication apparatuses. An example of semiconductor manufacturing equipment adapted for use in an automated production line is photolithography equipment. Photolithography equipment is used for forming the fine patterns, such as circuit patterns, of semiconductor devices. To this end, photolithography equipment includes a spinner for coating a wafer with a layer of photoresist and for coating an exposed wafer with a developing solution to develop the photoresist once it has been exposed, an exposure apparatus connected in-line with the spinner for exposing a wafer on which the layer of photoresist has been formed, and a transfer apparatus interposed between the spinner and the exposure apparatus. The transfer apparatus includes a buffer and a robot for transferring wafers from the spinner to the exposure apparatus via the buffer, thereby automating the production line.

However, in the case of photolithography equipment, the time required to complete a process in the spinner may be different from the time required to complete a process in the exposure apparatus. For example, the time it takes the spinner to coat a wafer may be less than the time it takes the exposure apparatus to irradiate (expose) a wafer. In this case, the robot of the transfer apparatus sequentially loads several coated wafers from the spinner into the buffer while a wafer is being exposed. After a wafer is exposed, the robot of the transfer apparatus searches for the first of the wafers loaded into the buffer and then transfers that wafer to the exposure apparatus.

Moreover, in semiconductor device fabrication equipment, such as photolithography equipment, in which the time it takes to perform a first process is shorter than the time it takes to perform the following process, a great deal of the run time of the equipment is spent transferring the wafers to and from the buffer. That is, such equipment has low productivity. In addition, the wafers must pass through a relatively high number of units of the equipment. Thus, the wafers are likely to become scratched or broken.

### SUMMARY OF THE INVENTION

An object of the present invention is to provide fabrication equipment and a method of using the same that are capable of minimizing the total transfer time of a substrate through processing apparatuses that are linked in-line in the equipment.

Another object of the present invention is to provide fabrication equipment and a method of using the same capable of minimizing the number of times a substrate is transferred in and out of parts of the equipment when the equipment includes processing apparatuses that are linked in-line.

According to a first aspect of the present invention, there is provided fabrication equipment including a first apparatus having a first process execution part that carries out a first process on a substrate, a second apparatus linked in-line to the first apparatus and comprising a unit that carries out a second consecutive process on the substrate, and a speed regulator operatively connected to the first and second apparatuses. The speed regulator detects durations of the first and second processes, respectively, and is configured to compare the durations. The speed regulator also is configured to issue a control signal to the first apparatus that adjusts the speed at which the first process is executed when the duration of the first process is shorter than the duration of the second process.

The first process execution part may comprise at least two units which each perform a step in the execution of the first process, and a robot, having a working envelope that encompasses at least the two units. The robot thus transfers a substrate from one of the two units to the other of the two units. In this case, the speed regulator is operatively connected to the robot so as to control the timing by which the robot transfers a substrate.

The first apparatus may be a spin-coating apparatus and the second apparatus may be an exposure apparatus of photolithography equipment. In this case, the first process execution part comprises a spin-coating unit having a rotary chuck, a source of photoresist, and a supply nozzle connected to the source of photoresist, and the exposure apparatus comprises an exposure unit that includes a light source, a substrate stage dedicated to support a substrate that is to be exposed, and a reticle stage dedicated to support a reticle. Furthermore, the spin-coating apparatus may also comprise a second process execution part that carries out a third process on the substrate. In particular, the second process execution part carries out a developing process. To this end, the second process execution part comprises a spin-coating unit having a rotary chuck, a source of a developing solution, and a supply nozzle connected to the source of developing solution.

According to another aspect of the present invention, there is provided fabrication equipment including a plurality of apparatuses linked in-line to one another to thereby form an automated production line, and a speed regulator operatively connected to the apparatuses. The apparatuses comprise at least three units in which consecutive processes are performed, respectively, on a substrate. The speed regulator is operative to detect durations of the consecutive processes, respectively, and is configured to compare the durations. The speed regulator is also configured to issue a control signal to the apparatus in which one of the processes is performed to adjust the speed at which that process is executed when the duration of the process is shorter than the duration of the process that is performed consecutively thereto.

According to a third aspect of the present invention, there is provided a fabrication method which includes performing a first process on a substrate using a first processing apparatus, performing a second consecutive process on the substrate using a second processing apparatus linked to the first apparatus, detecting durations of the first and second processes, respectively, and comparing the durations, and making a determination as to whether the duration of the first process is shorter than the duration of the second process. Also, the speed at which the first process is executed is adjusted when it is determined that the duration of the first process is shorter than the duration of the second process.

Respective steps of the first process may be performed in at least two units, respectively, of the first processing apparatus. In this case, the substrate is transferred from at least one of the units to another of the units. Also, the adjusting of the speed at which the first process is executed is carried out by delaying the transfer of the substrate from one of the units to the other of units. Alternatively, the adjusting of the speed at which the first process is executed is carried out by delaying the transfer of the substrate from one of the units of the first processing apparatus to the second processing apparatus. Preferably, the speed at which the first process is carried out is adjusted such that the duration of the first process is made equal to the duration of the second process.

According to yet another aspect of the present invention, the first process includes coating a wafer with photoresist, and the second process includes exposing the wafer to light directed through a reticle. In addition, a third process of developing the exposed wafer may be carried out preferably using the first processing apparatus. In this case, a duration of the third process is detected, the durations of the second and third processes are compared, and a determination is made as to whether the duration of the second process is shorter than the duration of the third process. Also, the speed at which the second process is executed is adjusted when the duration of the second process is shorter than the duration of the third process. Preferably, the speed at which the second process is executed is adjusted such that the duration of the second process is made equal to the duration of the third process.

### BRIEF DESCRIPTION OF THE DRAWINGS

The foregoing and other objects, features and advantages of the invention will be apparent from the following detailed description of the preferred embodiments of the invention, as illustrated in the accompanying drawings. The drawings are not necessarily to scale, emphasis instead being placed upon illustrating the principles of the invention.

FIG. 1 is a schematic diagram of an embodiment of semiconductor device fabrication equipment in accordance with the present invention.

FIG. 2 is a block diagram of the semiconductor device fabrication equipment shown in FIG. 1.

FIG. 3 is a flowchart showing a fabrication method in accordance with the present invention.

FIG. 4 is a flowchart showing a fabrication method comprising photolithography in accordance with the present invention.

### DETAILED DESCRIPTION OF THE PREFERRED EMBODIMENTS

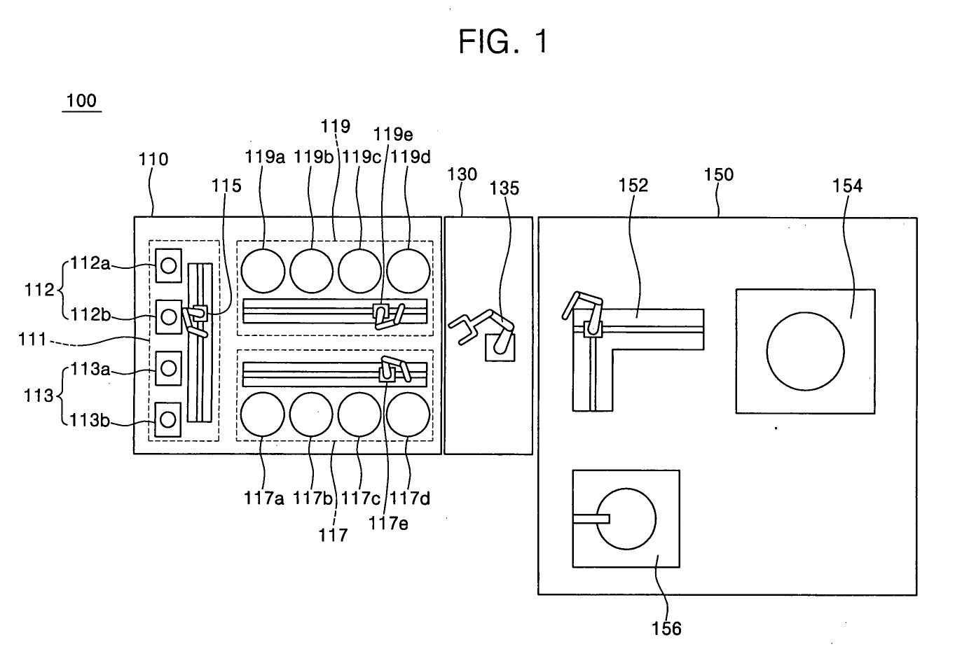

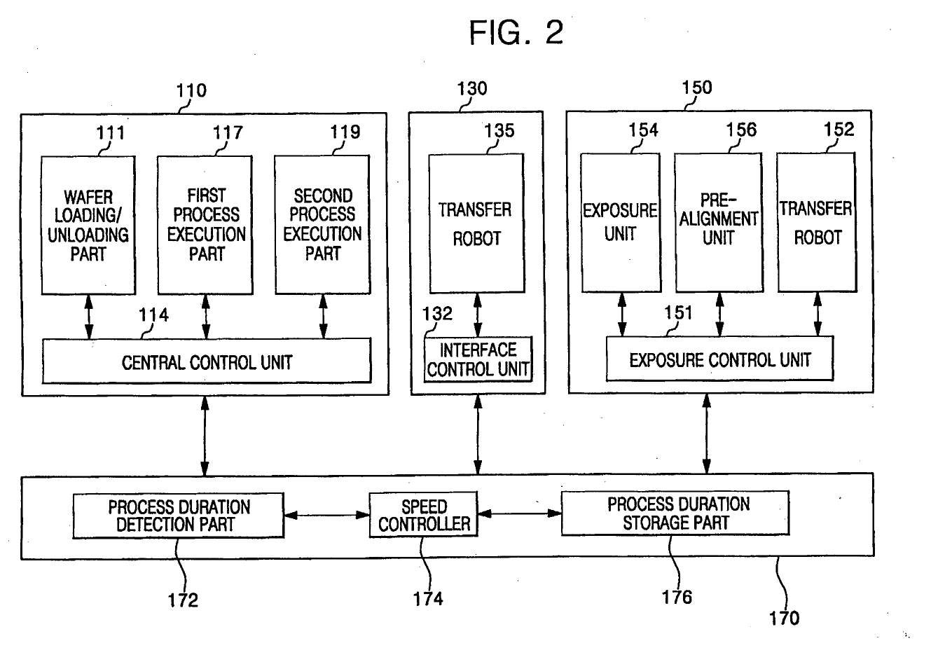

The present invention will now be described more fully hereinafter with reference to the accompanying drawings. In this respect, like reference numbers designate like elements in FIGS. 1 and 2.

Referring to FIGS. 1 and 2, the semiconductor device fabrication equipment of the present invention comprises at least two self-contained apparatuses linked in-line for performing sequential processes. For example, the semiconductor device fabrication equipment may be photolithography equipment 100. The photolithography equipment 100 includes a spin-coating apparatus 110 for coating unexposed wafers with photoresist and for coating exposed wafers with developing solution, an exposure apparatus 150 linked in-line to the spin-coating apparatus 110 for exposing wafers that have been coated with photoresist in the spin-coating apparatus 110, a transfer apparatus 130 interposed between and connecting the spin-coating apparatus 110 and the exposure apparatus 150, and a speed regulator 170 for detecting the time it takes the apparatuses 110 and 150 to perform each process and for adjusting those times. More specifically, the spin-coating apparatus 110 includes a wafer loading/unloading part 111, a first process execution part 117 for coating a wafer with photoresist, a second process execution part 119 for developing a wafer exposed in the exposure apparatus 150, and a central control unit 114 for controlling the general operation of the spin-coating apparatus 110.

The wafer loading/unloading part 111 includes a loading unit 112 at which wafers to be coated, exposed and developed are loaded into the equipment 100, an unloading unit 113 from which the coated, exposed and developed wafers are unloaded from the equipment, and a transfer robot 115 for transferring wafers from the loading unit 112 to the first process execution part 117 and for transferring wafers from the second process execution part 119 to the unloading unit 113 all under the control of the central control unit 114. The loading unit 112 may comprise a plurality of loading stations. Preferably, the loading unit 112 includes a first loading station 112a and a second loading station 112b. In addition, the unloading unit 113 may also comprise a plurality of stations. Preferably, the unloading unit 113 includes a first unloading station 113a and a second unloading station 113b. In any case, the loading and unloading units 112 and 113 each include at least one wafer cassette for stocking a plurality of wafers, e.g., about 25 wafers, and a support for the wafer cassette.

The first process execution part 117 includes at least one spin-coating unit 117a for coating a wafer with photoresist, at least one baking unit 117b for baking the layer of photoresist formed on the wafer by the spin-coating unit 117a, and a transfer robot 117e that receives a wafer from the loading unit 112, transfers the wafer to the spin-coating unit 117a and transfers the wafer from the spin-coating unit 117a to the baking unit 117b all under the control of the central control unit 114. The spin-coating unit 117a may include a chuck for fixing the wafer in place and rotating the wafer, a supply of photoresist, and a nozzle for supplying the photoresist onto the rotating wafer. The baking unit 117b may include a plate on which a wafer is mounted, and a heater for heating the plate.

The first process execution unit 117 may further include at least one adhesive agent coating unit 117c for applying an adhesive on the wafer before the wafer is coated with photoresist to increase the ability of the photoresist to adhere to the wafer, and at least one cooling unit 117d for cooling the heated wafer to room temperature. In this case, the adhesive agent coating unit 117c may include a plate on which the wafer is mounted, a source of the adhesive, an injection nozzle for supplying the adhesive onto the wafer mounted on the plate, and a heater for selectively heating the plate. The adhesive may be hexamethyldisilazane (HMDS). The cooling unit 117d may include a plate on which the wafer is mounted, and a temperature regulator for regulating the temperature of the plate to reduce the temperature of the wafer and maintain the wafer at room temperature. Therefore, the wafer heated by the baking unit 117b can be cooled by the cooling unit 117d.

The second process execution part 119 includes at least one developing unit 119a for supplying a developing solution onto the exposed wafer to develop the wafer, at least one baking unit 119b for baking a developed or exposed wafer, and a transfer robot 119e that receives a wafer from the transfer apparatus 130, and transfers an exposed or developed wafer to the baking unit 119b all under the control of the central control unit 114. The developing unit 119a may include a chuck for fixing and rotating the wafer, a supply of developing solution, and a nozzle for supplying the developing solution onto the rotating wafer. The baking unit 119b may include a plate on which the wafer is mounted, and a heater for heating the plate. Therefore, a wafer developed in the developing unit 119a or a wafer exposed in the exposure apparatus 150 can be transferred to the baking unit 119b and then baked.

The second process execution part 119 may further include at least one cooling unit 119c for cooling a wafer, and at least one edge exposure unit 119d for exposing an edge of the wafer. In this case, the cooling unit 119c may include a plate on which the wafer is mounted, and a temperature regulator for regulating the temperature of the plate to cool the wafer to room temperature and maintain the wafer at room temperature. The edge exposure unit 119d may include a chuck for fixing and rotating the wafer, and a light source for irradiating an edge of the rotating wafer with light emitted by the light source. Therefore, the edge of a wafer transferred to the second process execution part 119 can be exposed by the edge exposure unit 119d, and a wafer baked in the baking unit 119b can be cooled to room temperature by the cooling unit 119c.

In addition to controlling the general operation of the spin-coating apparatus, the central control unit 114 also controls the first process execution part 117 and the second process execution part 119 in response to signals transmitted from the speed regulator 170 to adjust the speed at which the coating process is executed by the first process execution part 117 and the speed at which a developing process is executed by the second process execution part 119. For example, the central control unit 114 adjusts the speed at which the coating process is executed such that the time it takes the first process execution part 117 to perform a coating process is equal to the time it takes the second process execution part 119 to perform the following exposure process.

The exposure apparatus 150 includes a pre-alignment unit 156 for aligning a wafer prior to exposure, an exposure unit 154 for exposing the pre-aligned wafer, a transfer robot 152 that receives a wafer from the transfer apparatus 130 and transfers the wafer to the pre-alignment unit 156 and the exposure unit 154, and an exposure control unit 151 for controlling the general operation of the exposure apparatus 150.

More specifically, the pre-alignment unit 156 includes a chuck for fixing a wafer in place and rotating the wafer, and a photo sensor for detecting a reference point such as a notch in or a flat zone of the wafer. The pre-alignment unit 156 detects the reference point while the wafer is being rotated by the chuck, and then stops the chuck such that the reference point faces in a predetermined direction. Accordingly, the wafer is aligned with the exposure unit 154.

The exposure unit 154 includes a substrate stage on which a wafer is mounted, a light source for emitting light of a predetermined wavelength, a reticle stage and a reticle supported by the stage in an optical path extending from the light source to the substrate stage. The reticle has a predetermined pattern corresponding to a circuit pattern, for example, to be formed on the wafer. The exposure unit 154 directs light of a predetermined wavelength through the reticle and onto a wafer mounted to the stage. As a result, an image of the pattern of the reticle is transferred to the layer of photoresist on the wafer. That is, the wafer is exposed.

The transfer robot 152 transfers wafers in the exposure apparatus 150. Specifically, the transfer robot 152 transfers a wafer from the transfer apparatus 130 to the pre-alignment unit 156, and transfers a wafer aligned in the pre-alignment unit 156 to the exposure unit 154. Also, the transfer robot 152 transfers a wafer exposed in the exposure unit 154 back to the transfer apparatus 130.

The exposure control unit 151 is connected to the pre-alignment unit 156, the exposure unit 154, and the transfer robot 152, and controls the general operation of the exposure apparatus 151. In addition, the exposure control unit 151 controls the pre-alignment unit 156, the exposure unit 154 and the transfer robot 152 in response to signals transmitted from the speed regulator 170 to adjust the time it takes for an exposure process to be executed in the exposure apparatus 150. For example, the exposure control unit 151 adjusts the speed at which the exposure process is executed such that the time it takes to perform the exposure process is equal to the time it takes the spin-coating apparatus 110 to perform the subsequent developing process.

As described above, the transfer apparatus 130 transfers wafers between the spin-coating apparatus 110 and the exposure apparatus 150. To this end, the transfer apparatus 130 may include a transfer robot 135 for reciprocating between the spin-coating apparatus 110 and the exposure apparatus 150, and an interface control unit 132 for controlling the operation of the transfer robot 135.

Alternatively, the photolithography equipment 100 may omit the transfer apparatus 130. That is, the spin-coating apparatus 110 and the exposure apparatus 150 may be directly connected to each other. In this case, the transfer robot 117e of the first process execution part 117 of the spin-coating apparatus 110 transfers wafers directly to the transfer robot 152 of the exposure apparatus 150, and the transfer robot 152 of the exposure apparatus 150 transfers wafers directly to the transfer robot 119e of the second process execution part 119 of the spin-coating apparatus 110.

The speed regulator 170 adjusts the run time of all parts of the photolithography equipment 100. To this end, the speed regulator 170 may include a process duration detection part 172 connected to the apparatuses 110 and 150 to detect, in real time, the time it takes for the apparatuses 110 and 150 to perform each of the processes that occur in the apparatuses, and a speed controller 174 for controlling the speed at which each of the processes is executed in response to the information detected by the process consuming time detection part 172. In addition, the speed regulator 170 may further include a process duration storage part 176 that stores the durations of the respective processes performed by the apparatuses 110 and 150. In this case, the photolithography equipment 100 must perform all of the processes at least once before controlling the speed at which any of the processes is subsequently executed.

The speed regulator 170 is an automated machine controller of the type that can be realized by those of ordinary skill in the art using conventional technology, per se. For example, the process duration detection part 172 of the speed regulator 170 may be realized through the use of counters triggered by the control units 114, 132 and 151 of the spin-coating apparatus 110, the transfer apparatus 130 and the exposure apparatus 150. The process duration storage part 176 of the speed regulator 170 may be realized as an electronic memory device. The speed controller 174 may be realized as a data processor comprising comparitors for comparing data stored in the process consuming time storage part 176.

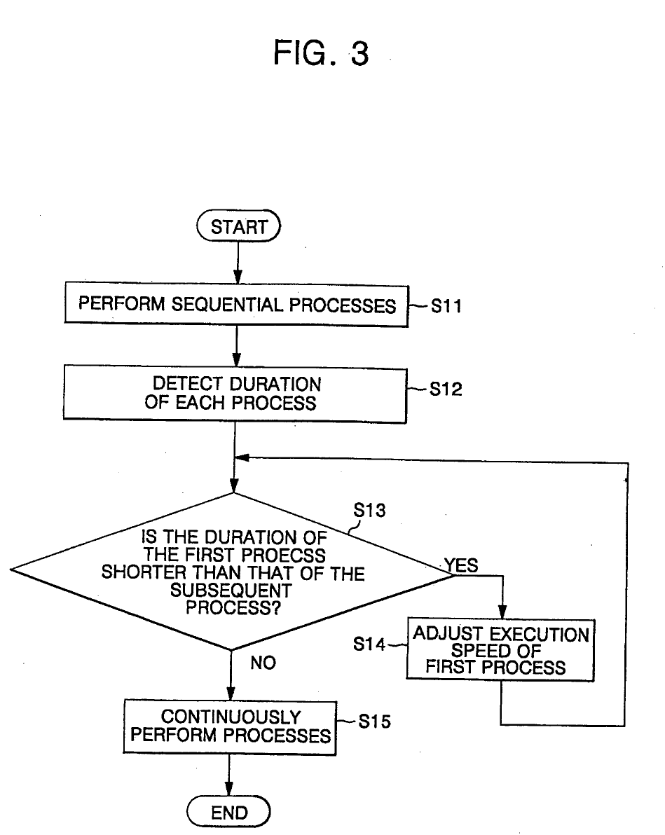

A general method of processing substrates in accordance with the present invention will be described hereinafter with reference to FIG. 3.

First, a substrate such as a semiconductor wafer is subjected to a plurality of consecutive processes (S11).

At this time, the processes are monitored and the respective durations of the processes are detected and quantified (S12). The duration of a process may be defined as the amount of time the substrate spends in an apparatus or unit in which the process takes place, i.e., the duration of a process is not necessarily limited to the time the substrate is actually being subjected to a particular process in the apparatus.

In addition, values representing the respective durations of the processes may be stored in a memory. Then, the durations of the respective processes are compared (S13). Specifically, the duration of a first process is compared with the duration of the process that immediately follows the first process to determine whether the duration of the first process is shorter than that of the subsequent process.

If the duration of the first process is not shorter than that of the subsequent process, the fabrication equipment continuously performs the processes (S15). However, if the duration of the first process is shorter than that of the subsequent process, the apparatus that performs the first process is adjusted (S14). Preferably, the apparatus for performing the first process is controlled to change the speed at which the first process is executed such that the duration of the first process is equal to the duration of the subsequent process. Then the fabrication equipment compares the durations of the two processes again (S13) and continues to adjust the apparatus for performing the first process, if necessary.

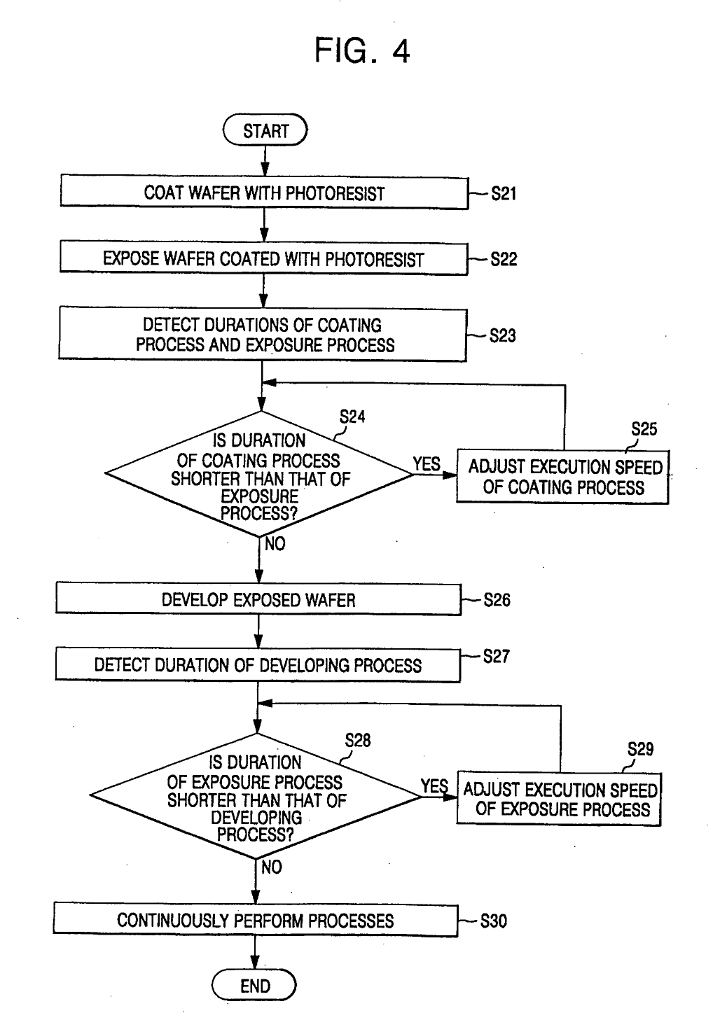

An application of the above-described method to the fabricating of semiconductor devices, in accordance with the present invention, will now be described with reference to FIGS. 1, 2 and 4.

First, a wafer that has been loaded into the semiconductor device fabrication equipment, i.e., the photolithography equipment 100, is coated with photoresist in the first process execution part 117 of the spin-coating apparatus 110 (coating process S21). Then, the coated wafer is transferred to the exposure apparatus 150 by the transfer robot 117e of the first process execution part 117. Next, the exposure apparatus 150 irradiates the coated wafer to transfer an image of the pattern of the reticle to the layer of photoresist (exposure process S22).

At this time, the speed regulator 170 connected to the spin-coating apparatus 110 and the exposure apparatus 150 detects the durations of the respective processes performed by the apparatuses 110 and 150 (S23). More specifically, the process duration detection part 172 detects the durations of the coating process and the exposure process in real time.

The duration of the coating process may be the amount of time that has elapsed beginning when the wafer is transferred to the spin-coating unit 117a and ending when the wafer has been cooled in the cooling unit 117d (or has been transferred by the robot 117e of the spin-coating apparatus 110). The duration of the exposure process may be the amount of time that has elapsed beginning when a wafer is transferred to the pre-alignment unit 156 and ending when the wafer is exposed in the exposure unit 154 (or has been transferred by the robot 152 of the exposure apparatus 150 back to the spin-coating apparatus 110). In addition, values representing the durations of the respective processes performed using the apparatuses 110 and 150 may be stored in the process duration storage part 176. In this case, the speed regulator 170 reads the values stored in the process duration storage part 176 after the processes have been performed at least once.

Then, the speed regulator 170 compares the durations of the coating process and the exposure process. Specifically, the speed regulator 170 determines whether the duration of the coating process is shorter than that of the exposure process (S24).

If the duration of the coating process is not shorter than that of the exposure process, the exposed wafer is transferred to the second process execution part 119 of the spin-coating apparatus 110 to develop the exposed wafer (S26). On the other hand, if the duration of the coating process is shorter than that of the exposure process, the speed regulator 170 transmits a predetermined signal to the spin-coating apparatus 110 to adjust the speed at which the coating process is performed (S25). Preferably, the spin-coating apparatus 110 is adjusted such that the duration of the coating process becomes equal to the duration of the exposure process (S25).

Specifically, the central control unit 114 delays the transfer of a wafer from one of the units of the first process execution part 117 to another of the units in response to the signal transmitted from the speed controller 174, or delays the transfer of a wafer from the first process execution part 117 to the transfer apparatus 130. In other words, the central control unit 114 controls the transfer robot 117e to delay the transfer of the wafer from the spin-coating unit 117a to the baking unit 117b, from the baking unit 117b to the adhesive agent coating unit 117c or cooling unit 117d, or from the cooling unit 117d to the transfer apparatus 130.

Then, the photolithography equipment 100 compares the durations of the two processes again (S24) and therefore, deems the durations to be equal, for example. As a result, the photolithography equipment 100 transfers the exposed wafer to the second process execution part 119 of the spin-coating apparatus 110 to develop the exposed wafer (S26). At this time, the speed regulator 170 of the photolithography equipment 100 detects the duration of the developing process that is being carried out immediately after the exposure process (S27).

Next, the speed regulator 170 compares the durations of the exposure process and the developing process, and determines whether the duration of the exposure process is shorter than that of the developing process (S28). In this case, the duration of the developing process may be the actual time the wafer being developed spends in the second process execution part 119. If the duration of the exposure process is not shorter than that of the developing process, the photolithography equipment 100 transfers the developed wafer to the unloading unit 113 of the spin-coating apparatus 110. The wafer may then be further processed and another wafer is coated with photoresist in the spin-coating apparatus (S30).

On the other hand, if the duration of the exposure process is shorter than that of the developing process, the speed regulator 170 transmits a predetermined signal to the exposure apparatus 150 to adjust the execution speed of the exposure process. Preferably, the speed regulator 170 controls the exposure process such that the duration of the exposure process becomes equal to the duration of the developing process that immediately follows the exposure process (S29). Specifically, the speed controller 174 of the speed regulator 170 transmits a signal to the exposure control unit 151 of the exposure apparatus 150. As a result, the exposure control unit 151 delays the transfer of a wafer from one unit of the units of the exposure apparatus 150 to another of the units, or delays the transfer of a wafer from the exposure apparatus 150 to the transfer apparatus 130. In other words, the exposure control unit 151 controls the transfer robot 152 to delay the transfer of a wafer from the pre-alignment unit 156 to the exposure unit 154, or to delay the transfer of a wafer from the exposure unit 154 to the transfer apparatus 130.

Then, the photolithography equipment 100 compares the durations of the two (exposure and developing) processes again (S28) and therefore, deems the durations to be equal, for example. The wafer is then transferred for further processing. That is, the photolithography equipment 100 transfers the developed wafer to the unloading unit 113 of the spin-coating apparatus 110, and another wafer undergoes the coating process (S30).

In accordance with the present invention, as described above, the durations of the respective processes, such as coating, exposure and developing process performed by the photolithography equipment 100, are made to be equal. Therefore, a wafer subjected to the coating process or the exposure process can be instantly transferred to the apparatus that performs the subsequent process on the wafer. Accordingly, several wafer transfers that occur in the conventional art can be omitted, e.g., the loading of the wafers into a buffer after the wafers are processed, and the unloading of the wafers from the buffer just before the wafers are subsequently processed can be omitted. Hence, the total time during which a wafer is being transferred in the semiconductor fabrication equipment is minimized according to the present invention, thereby improving productivity. In addition, the wafers are much less likely to become scratched or broken.

Finally, although the present invention has been described herein with respect to the preferred embodiments thereof, the present invention is not so limited. Accordingly, various changes in form and details may be made to the preferred embodiments without departing from the true spirit and scope of the present invention as set forth in the following claims.

What is claimed is:

1. Fabrication equipment comprising:
a first apparatus having a first process execution part that carries out a first process on a substrate;
a second apparatus linked in-line to the first apparatus and comprising a unit that carries out a second process on the substrate, wherein the first and second processes are consecutive processes in the fabrication of a device from the substrate; and
a speed regulator operatively connected to the first and second apparatuses to detect durations of the first and second processes, respectively, and configured to compare the durations and issue a control signal to the first apparatus that adjusts the speed at which the first process is executed when the duration of the first process is shorter than the duration of the second process.

2. The fabrication equipment according to claim 1, wherein the first process execution part comprises at least two units which each perform a step in the execution of the first process, and a robot having a working envelope that encompasses at least the two units and transfers a substrate from one of the two units to the other of the two units, and the speed regulator is operatively connected to the robot so as to control the timing by which the robot transfers a substrate.

3. The fabrication equipment according to claim 1, wherein the first apparatus is a spin-coating apparatus and first process execution part comprises a spin-coating unit having a rotary chuck, a source of photoresist, and a supply nozzle connected to the source of photoresist, and the second apparatus is an exposure apparatus and the unit of said exposure apparatus is an exposure unit that includes a light source, a substrate stage dedicated to support a substrate that is to be exposed, and a reticle stage dedicated to support a reticle bearing a pattern the image of which is to be transferred to a substrate supported by the substrate stage.

4. The fabrication equipment according to claim 3, wherein the first apparatus comprises a second process execution part that carries out a third process on the substrate, the second process execution part comprising a spin-coating unit having a rotary chuck, a source of a developing solution, and a supply nozzle connected to the source of developing solution.

5. The fabrication equipment according to claim 4, wherein the speed regulator is also operatively connected to the third apparatus to detect a duration of the third process, and is configured to compare the durations of the second and third processes and issue a control signal to the second apparatus that adjusts the speed at which the second process is executed when the duration of the second process is shorter than the duration of the third process.

6. Fabrication equipment comprising:
a plurality of apparatuses linked in-line to one another to thereby form an automated production line, the apparatuses comprising at least three units in which consecutive processes are performed, respectively, on a substrate; and
a speed regulator operatively connected to the apparatuses to detect durations of the consecutive processes, respectively, and configured to compare the durations and issue a control signal to the apparatus in which one of the processes is performed to adjust the speed at which said one of the processes is executed when the duration of said one of the processes is shorter than the duration of the process that is performed consecutively to said one of the processes.

7. The fabrication equipment according to claim 6, wherein the apparatuses each comprises at least two units which each perform a step in the execution of a respective one of the processes, and a robot having a working envelope that encompasses the at least the two units and transfers a substrate from at least one of the two units to another of the at least two units, and
the speed regulator is operatively connected to the robots so as to control the timing by which the robots transfer substrates.

8. A fabrication method comprising:
performing a first process on a substrate using a first processing apparatus;
performing a second process, consecutive to the first process, on the substrate using a second processing apparatus linked to the first apparatus such that first and second processing apparatus are disposed in-line;
detecting durations of the first and second processes, respectively, and comparing the durations; and
making a determination as to whether the duration of the first process is shorter than the duration of the second process, and adjusting the speed at which the first process is executed when the duration of the first process is shorter than the duration of the second process.

9. The fabrication method according to claim 8, wherein the performing of the first process comprises performing respective steps of the first process in at least two units, and transferring the substrate from at least one of the units to another of the units, and
and the adjusting of the speed at which the first process is executed comprises delaying the transfer of the substrate from said one of the units to the other of units

10. The fabrication method according to claim 8, wherein the adjusting of the speed at which the first process is executed comprises delaying the transfer of the substrate from one of the units of the first processing apparatus to the second processing apparatus.

11. The fabrication method according to claim 8, wherein the adjusting of the speed at which the first process is executed comprises controlling the first processing apparatus such that the duration of the first process is equal to the duration of the second process.

12. The fabrication method according to claim 8, wherein the first process comprises coating a wafer with photoresist, and the second process comprises exposing the wafer to light directed through a reticle.

13. The fabrication method according to claim 12, and further comprising a third process of developing the exposed wafer, detecting a duration of the third process, comparing the durations of the second and third processes, making a determination as to whether the duration of the second process is shorter than the duration of the third process, and adjusting the speed at which the second process is executed when the duration of the second process is shorter than the duration of the third process.

14. The fabrication method according to claim 13, wherein the adjusting of the speed at which the second process is executed comprises controlling the second processing apparatus such that the duration of the second process is equal to the duration of the third process.
